(19) United States
(12) Patent Application Publication
(10) Pub. No.: US 2012/0315411 A1
(43) Pub. Date: Dec. 13, 2012

(54) Vacuum insulation panel - [ which prevents heat loss or heat gain in a building ]

(76) Inventor: Jerry Castelle, Old Bethpage, NY (US)

(21) Appl. No.: 13/067,541

(22) Filed: Jun. 7, 2011

(51) Int. Cl. B32B 1/08

(52) U.S. Cl. 428/34.1

(57) ABSTRACT

This invention concerns an article of manufacture for building material insulation, wherein the article of insulation includes vessels which are evacuated of its air contents. As such, it relates to an apparatus, completely devoid of air and in a complete state of vacuum which totally prevents or drastically retards the transmigration of heat energy loss via conduction and convection from the interior of a building's space to the outside environment during the winter months; and vice versa, thus retarding the gain of environmental heat into said space during the hot summer months.

### BACKGROUND OF THE INVENTION

This invention relates to building insulation, as measured by three performance characteristics; viz. (1) thermal conductance, or (K-value); (2) thermal resistance, or (R-value), and (3) thermal transmittance, or (U-value) and in particular to the use of vacuum technology to prevent conductance and convection from adversely affecting the interior temperature and level of comfort within a building.

### FIELD OF THE INVENTION

This invention relates to vacuum insulated panels (VIP) covering the complete envelope of the building within closed vacuum evacuated vessels, thereby specifically increasing the R-value performance characteristic of the building insulation material.

### DESCRIPTION OF THE PRIOR ART

This instant invention is one of three separate applications by the same inventor for new utility patents based upon the aggregate related performance characteristics in series utilizing vacuum technology within a building's envelope; viz. (1)—thermal conductance, or K-value; (2)—thermal resistance, or R-value and (3)—thermal transmittance, or U-value; which are all measurements used to quantify the degree of prevention or retardation of heat loss or heat gain within a building's interior. R-value is in fact the reciprocal of U-value. A definition of R-value based on apparent thermal conductivity, or K-value, has been proposed in document C168 published by the American Society for Testing and Materials. This bulletin describes heat being transferred by all three mechanisms, i.e.—conduction, radiation, and convection; whereby said three separate insulation assemblies being sought for patent approval affect all three latter modalities, which favorably impact the three aforementioned performance characteristics of an insulation material to resist conducted, radiated or convective heating. As such, this present invention thus can best be characterized as the middle-most VIP insulation component, i.e. “vacuum insulated panel” or Assembly “B” within a building envelope; a/k/a by Provisional Patent Application (P.P.A.) Number U.S. 61/355,814. Whereas, the most interior VIP insulation component is characterized as Assembly “A” within the same building envelope, a/k/a P.P.A. Number (not yet filed). Finally, the most exterior VIP insulation component is characterized as Assembly “C” within the same building envelope, a/k/a P.P.A. Number (not vet filed).

Traditionally, building insulation materials consist of thermal insulation used in the construction of buildings. These materials as conventionally used can unfortunately only retard heat transfer by the three aforementioned mechanisms; i.e. conduction, radiation or convection; whereby these insulation materials are employed, either singularly, or in varying combinations to achieve the desired outcome (which is usually thermal comfort with reduced energy consumption). Their main disadvantage however, is that they do not totally prevent the transfer of energy, but instead can only slow the transmigration of heat molecules. It is well known in the prior art that excellent thermal insulation capability has been achieved by creating a vacuum state within a hermetically sealed closed vessel. Perhaps the most common device utilizing this principle is the ordinary ubiquitous thermos bottle or vacuum Dewar flask. Whereas, the novel approach to vacuum technology within this invention's three assemblies solves the transmigration of heat energy molecules dilemma by completely stopping the molecular transfer of heat. Thus, conventional insulation's usefulness can either be categorized by its composition (material), or by its form (structural or non-structural), or by its functional mode (conductive, radiant, convective). Some of the more conventional products used today are wood chips, fiber-glass batts, urea formaldehyde sprayed in-foam, cellulose loose fill, molded polystyrene and polyurethane rigid panels. The performance capabilities of these aforementioned insulation products are classified via an R-rating resistance factor; which is to say R-value. A rating of R-1 per inch is attributable to wood chips; while the R-value rating proportionately increases within this list to a maximum R-rating of R-7 per inch for polyurethane rigid panels. Today, many manufacturers have sought to increase the R-ratings of insulation with questionable success, and therefore the present status quo abounds with no new technological improvements on the horizon.

It is a fact that the thermo-molecular energy of heat transmission molecules always flows from a warmer heat source to a colder area. Unfortunately, conventional insulation materials can only slow the pace of this transmigration of heat energy from the interior of a building's heated space to the outside cold air during the winter months. This transmigration of energy also occurs during the hot summer months as well, but only in the reverse direction. Therefore, a major problem exists today in that the threat of oil prices and the escalating quantity of importation of crude oil barrels to heat and cool a building has become a source of deep concern attributable to the high cost of imported crude oil. Especially since we are quickly running out of cheaply produced crude oil. This high cost is eventually passed on to a building's owner to both heat and cool a building.

Therefore, should the price of heating oil rise to $5 per gallon, then this will become a major factor for owners in selecting the most energy efficient insulating material for their buildings. Since heat molecules via convection air currents rise, then the predominant loss from, . . . or gain of heat into, a building's interior is via the structure's ceiling or roof. Accordingly, this invention's array of combinations via the three different insulation assemblies; i.e. the interior-most VIP component as Assembly “A”; plus the middle-most VIP component as Assembly “B”; (which is this instant invention) and finally the exterior-most VIP component as Assembly “C”; . . . affords an owner of any building, the best possible solution in overcoming the disadvantages and pitfalls of each of the aforementioned conventionally used materials within their quest to save energy. This is expressly enhanced with the use of this invention's quintessential avant-garde vacuum technology, which heretofore has not been used in building construction today. Therefore, this invention constitutes a fresh and different approach to solving this transmigration problem, where the heat from a household compost utilized within Assembly “C” can now contribute to heat a building's interior space. This assembly component alone is a fabulous novel achievement! Accordingly, science dictates that the only forces at work for the transfer of heat energy in a building is via conduction, convection and radiant energy. Thus, the perfect insulator becomes in fact a vacuum. In a vacuum, heat cannot transfer by conduction, because there are no molecules present to collide with and relay the heat energy via molecular vibrations. It is for this same reason that convection heat transfer in a vacuum also fails, since there is no fluid medium (i.e. no air present) for thermo-molecular transfer to take place. Therefore, in a vacuum, only radiant heat transfer can take place in the form of photon emission. Assembly “A” however, within this tripartite scheme of distinct separate invention assemblies, thus retards heat molecular transmigration from this loss of radiant energy. By any large, the utility and principle of vacuum insulation technology is well known in the prior art. However, this present invention; viz. Assembly “B”, differs from those of the prior art in that it commands a unique design, whereby the maximum R-value per inch utilized within a typical 3½″ stud wall space is estimated to be R-50 per inch; or in reality, R-175 for the total stud space of 3½ inches. Therefore, a discussion of the related prior art, of which the present inventor is aware, and its differences and distinctions from this present invention is provided herein as follows:

U.S. Pat. No. 7,562,507 issued on Oct. 20, 2005 to Wallace E. Fleming, titled “Vacuum Insulated Building Panel” describes an assembly of two parallel plates separated by a post frame, whereby plate separation is maintained by spacers in the form of spheres that roll with any movement. It further describes two different kinds of VIP plates; glass plates to cover the windows in a building, and steel plates to cover the rest of the building, whereby each VIP element contains a clamping assembly consisting of bolts, nuts, and washers engaged to hold said plates and frame in close proximity prior to the evacuation vacuum. This VIP panel is relatively cumbersome; complex in terms of cost of assembly; weight of the materials on the building per se; and where the vacuum state is introduced at the building site after complex installation takes place.

U.S. Pat. No. 6,659,037 issued on Dec. 9, 2003 to Eric M. Hagopian, titled, “Method and Apparatus for the Evaluation of Vacuum Insulation Panels.” This invention describes a vacuum insulation panel (VIP) for use in temperature sensitive applications, whereby said VIP comprises: an open cell insulated core material; in addition to a barrier film enclosing said core material which is configured for maintaining a vacuum state within said vacuum insulated panel. Additionally, said invention also contains the quintessential vacuum detection indicator for detecting the presence of an effective vacuum state in the VIP panel, comprising a spring device within the cavity of said core material which is compressed in the presence of said vacuum state or perhaps expanded in the complete absence of a vacuum. It is thus noteworthy to mention that said invention claims 14 out of 20 vacuum detection indicators for evaluating the integrity of the vacuum state within this VIP patent. Thus, this invention instead concerns itself exclusively with the shipment and storage of temperature sensitive products such as blood, food, pharmaceuticals, vaccines, etc. within insulated shipping containers. Hence, the emphasis or patent protection of this invention is that VIP's have the potential to be reused, and therefore possibly damaged whereby the vacuum state within the VIP is compromised. Therefore, said VIP comprises a traditional barrier film to protect the integrity of the vacuum state within the evacuated core material. However, only via the presence of said vacuum detection indicator can the integrity of the effective vacuum state within the VIP be 6 ascertained. Hence, this prior art distinguishes itself as being non-infringing when compared to the present invention herein sought to be patented.

U.S. Pat. No. 5,792,539 issued on Aug. 11, 1998 to Rick Cole Hunter, entitled; “Insulation Barrier.” This invention describes a rigid multi-layered thermal insulation barrier which is by and large, a box within a box, much like a refrigerator, except that this invention's barrier is made of alternating stacking thermal insulation elements. It appears from the description of said invention that several embodiments may be selected. One, where the geometric shape of the stacked thermal insulation elements is a beam formed by a sine-like wave design. The other embodiment may be a cone-like entity. Thus, the thermal insulation elements vacillate between beam-like or cone-like designs. Additionally, the outer skins extend beyond the thermal insulation barrier to form an envelope around the barrier, thus providing edges which seal the envelope by utilizing an adhesive. The invention also describes an insulation panel comprised of an envelope of thin skin high gas barrier material and a thermal insulation barrier which supports said skin, the latter which surrounds said barrier, then becomes subsequently evacuated. Another chief distinction of this invention is the use of a getter material which entraps the residual gases within the VIP panel after evacuation takes place. Hence, the descriptive nature of this Rick Hunter invention appears vastly different from the described application under consideration for a provisional patent herein.

U.S. Pat. No. 5,756,179 issued on May 26, 1998 to Ralph B. Jutte, entitled “Insulating Modular Panels incorporating Vacuum Insulation Panels”. This prior art is distinguished from the instant invention herein under consideration whereby these insulating modular panels are produced as a continuous block where the gaps between the panels are produced as a continuous block; said gaps being filled with foam or preformed filler material to form a continuous core, which has applied to it a reinforcing material. In other words, the inner core of material consists of hollow panels filled with a foam-like mixture to create a foam filled panel having a fiber reinforced plastic skin (FRP). The design intent behind this prior art is cited as designed exclusively for refrigerated shipping containers, walk-in-coolers, refrigerators, and freezers. Although this invention states that each embodiment may contain at least one vacuum insulation panel, the description of the prior art is vague on this precise method of achieving a vacuum state. It does however, describe the process of folding the resin impregnated reinforcement materials upward and downward to cover the sides of the continuous enclosed core. The only reference to a vacuum state lies outside of the legal claims, and instead resides within the detailed description, which states that said enclosure core is evacuated to create a vacuum in the enclosure which thereby reduces heat transfer. It further describes the VIP panel as a 3 mil. thick stainless steel jacket formed into a pan shaped cavity for receiving insulating media and then welded tight to create a hermetic seal. Thus, the foregoing description of this patented VIP panel fails to make a similar comparison to the instant invention under consideration herein as possibly being infringing art. It is also noteworthy to mention that U.S. Pat. No. 5,527,411 is the same invention as the forgoing patented described.

U.S. Pat. No. 5,252,408 issued on Oct. 12, 1993 to John Bridges, Philip Neal and John Besser entitled, “Vacuum Insulated Panel and Method of Forming a VIP.” This invention relates to a vacuum insulated panel comprising first and second peripherally joined stainless steel metal panels defining a cavity, a compressed cake of silica gel positioned within said cavity, a device for assisting in creating a vacuum within the cavity; whereby the compressed cake comprises a particulate getter material. It also possesses a fiberglass reinforcing structure for preventing the getter material from coming into contact with the first and second metal panels. This invention is cited in particular for insertion within cabinet walls of refrigerators and freezers. The cavity is subsequently sealed at the periphery, after the evacuation of the panel of its air contents by heating the same for 2 hours at a temperature of 650° F. to achieve the desired vacuum; whereby the carbon or silica gel layer sandwiched between two fiberglass batts yielded an R-value of approximately 46. All of the foregoing thus describes an art form completely different and non-infringing when compared to the instant invention under consideration herein.

U.S. Pat. No. 5,500,305 issued on Mar. 19, 1996 to John Bridges, Philip Neal and John Besser entitled, “Vacuum Insulated Panel and Method of Making a VIP.” The description of this prior art is practically identical in every respect to the foregoing above described U.S. Pat. No. 5,252,408.

### DISADVANTAGES OF THE PRIOR ART

The prior art utilizing vacuum insulated panels (VIPs) is abundant with patent design schemes whose main thrust has been predominantly within refrigeration, freezers, walk-in-coolers, cold storage containers, etc. As such, its main inventive focus has been on the selection of a design intent which is not bulky or substantial in terms of width size; thus having to be incorporated within the appliance's physical refrigerated cabinet size and door width. Suffice it to say, the appliance industry can not tolerate a bulky sized appliance in order for it to fit through a building's doorway space. Accordingly, since the width of any refrigeration panel is much smaller in comparison to the width of a building's load bearing stud wall space, which is 3½″; then all of the prior art except one has not been effective as a VIP vacuum insulation panel within a building envelope. That one building insulation patent, viz. U.S. Pat. No. 7,562,507, however suffers from the following disadvantages. It is cumbersome and bulky; quite expensive and elaborate to install; and it is completely unaesthetic; whereby the evacuation of its air contents must take place in situ. Hence, no manufacturer to date has been able to solve the dilemma of how to incorporate a complete long lasting vacuum state within the 3½″ stud wall space without the inner core of the VIP panel collapsing from the tremendous atmospheric pressure of 14 lbs/square inch. Of course, generally speaking, vacuum forces can be overcome without imminent collapse, albeit at the expense or detriment of being both costly in material and labor, while also being cumbersome in design and unaesthetic in appearance. Therefore, to date, any of the foregoing described prior art has not proven to be either utilized or effective within a building's envelope.

### BACKGROUND OF THE INVENTION

### Objects and Advantages

Accordingly, several objects and advantages of my invention are as follows:

COST: Since only one prior art directly applies, then comparatively speaking, this instant VIP invention is very cost effective.

WEIGHT: This VIP invention is significantly lighter in weight than what is already known and therefore will not aversely impact upon the load bearing capacity of a building.

SIZE: This VIP invention is conveniently sized to fit within the limitations of a typical 3½″ stud wall space.

EASE OF PRODUCTION: This VIP invention is easier and cheaper to manufacturer than previously known counterparts. For example, each hermetically sealed closed vessel can be mass produced as readily as the average aluminum beverage can.

DURABILITY: This VIP invention, when finally vacuum sealed can last as long as the entire life cycle of the building itself.

NOVELTY: The uniqueness of this invention's design makes it completely different than all previously known counterparts and is a clever means to eliminate heating costs.

SOCIAL BENEFIT: This VIP invention will obviate the requirement and considerable expense to heat a building during the winter and to cool the building during summer months; while concomitantly saving millions of barrels of crude oil being imported into the USA. Additionally, it helps save the trade balance deficit payments made to OPEC nations.

RELIABLE: Once this VIP invention is vacuum sealed, it thus becomes extremely reliable; i.e. never needing to be replaced or repaired.

ECOLOGY: This product will help reduce global warming by eliminating smoke and carbon emissions from chimneys and smokestacks due to the burning of fossil fuels.

MARKET SIZE: As a tremendous social benefit, this VIP invention can enable the change in state building codes to promulgate into law the requirement of an increased R-value of R-175 within the building's envelope. Therefore, unlimited market size will then create much needed new jobs.

QUALITY: This VIP invention produces an R-value of R-175 within the building's 3½″ stud wall space, which is in marked contrast to the R-13 for the competition.

LONG LIF CYCLE: This VIP invention can potentially be sold for every building and therefore will justify the capital expenditures for tooling and marketing.

RELATED PRODUCTS ADDED: Related to this VIP invention is Assembly “C” (separate patent application) with its necessary added product line of compost bins and sales of organic matter and worms. Additionally, any retrofit within an existing building will necessitate having to remove existing gypsum wall board to install this product within the existing wall cavity.

SATISFIES EXISTING NEED: Marketing difficulties will be greatly eliminated because this VIP invention saves the expenditure of thousands of dollars to heat and cool buildings. Therefore, the product pays for and sells itself from the vast savings in heating and cooling costs over the duration of the building's life cycle.

DISTRIBUTION: This VIP invention will be easy to distribute and market.

SERVICE: This VIP invention does not require any service after installation.

BROAD PATENT COVERAGE: This VIP invention will be the only source for a product which performs a vital function by saving thousands of dollars each year in eliminated heating and cooling costs. Therefore, the latter savings will automatically transform into increased profitability. Hence, a veritable business monopoly due to the high number of sales anticipated.

### SUMMARY

The present invention is directed to a vacuum insulated panel (VIP) comprising hermetically sealed closed vessel elements, each formed of a structural malleable material having a geometric shape of a repetitive three dimensional design, whereby the unique alternating surface patterns permit the complete mating and interlocking of a plurality of identical elements by permanently bonding one to the other via a strong engineering adhesive. Subsequent to the bonded interlocking pattern taking place, this now cohesive array of a modular unit assembly undergoes the simultaneous evacuation within each element of its entire air contents; thereby producing a complete state of vacuum, which totally prevents the transmigration of heat molecular flux from occurring within a building envelope; while simultaneously creating an insulating device of vastly increased R-value.

### BRIEF DESCRIPTION OF THE DRAWINGS

FIG. 1—cross-section of Assembly “B” showing the side half vacuum canisters

FIG. 2—plan view drawn through the same assembly showing apex of vacuum canisters.

FIG. 3—perspective view showing right and left faces of the vacuum canister.

FIG. 3 a—the top front view of FIG. 3 showing raised Item #6 and depressed Item #7

FIG. 3 b—the bottom rear view of FIG. 3 showing raised Item #6 and depressed Item #7

FIG. 4—perspective view showing the bottom side of the vacuum canister.

FIG. 4 a—the top front view of FIG. 4 showing raised Item #8 and depressed Item #9

FIG. 4 b—the bottom rear view of FIG. 4 showing raised Item #8 and depressed Item #9

FIG. 4 c—view of knob shaped raised ridges before insertion into undercut depressions

FIG. 4 d—view of knob shaped raised ridges tightly inserted into undercut depressions

FIG. 5—front face view of the top of the vacuum canister.

FIG. 6—rear face view of the bottom of the vacuum canister. 10

FIG. 6 a—section drawn through the entire elevation of the vacuum canister.

FIG. 7—section drawn through the two layers comprising the lid-cap assembly.

FIG. 8—complete modular assembly of 15 full vacuum canisters+6 small side pieces.

FIG. 9—view of the optional open wire grid to offset possible collapse of canister.

FIG. 9 a—additional optional open wire grid to offset possible collapse of canister.

### DRAWINGS

### Reference Numbers

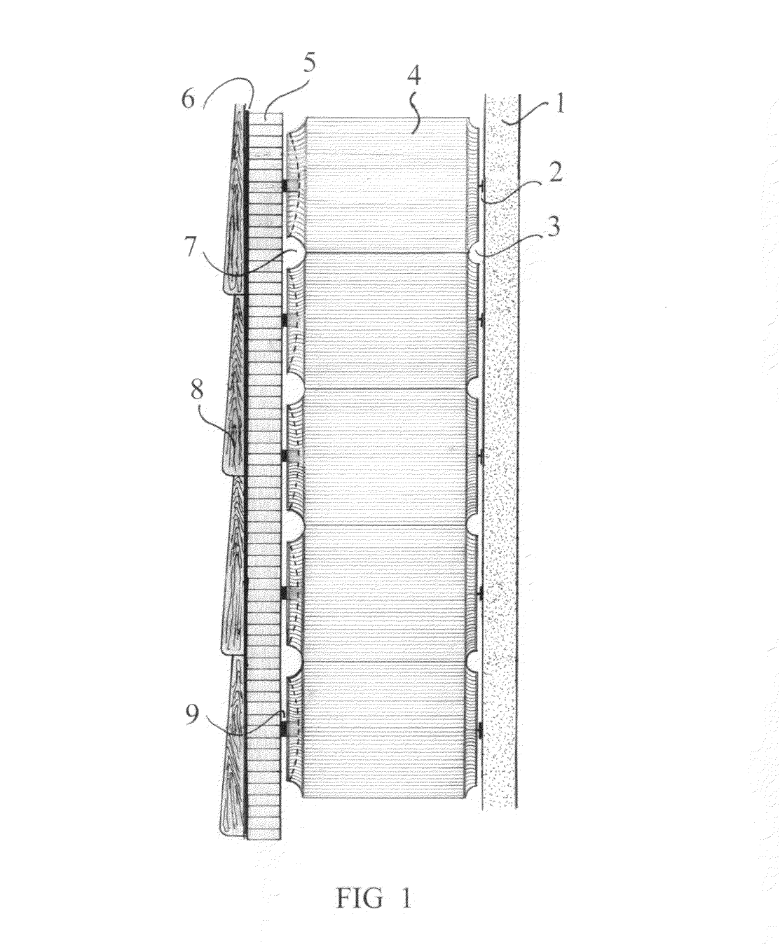

### FIG. 1

Item #1—gypsum wall board

Item #2—front spacer

Item #3—1st film of trapped insulating air at front of vacuum canister

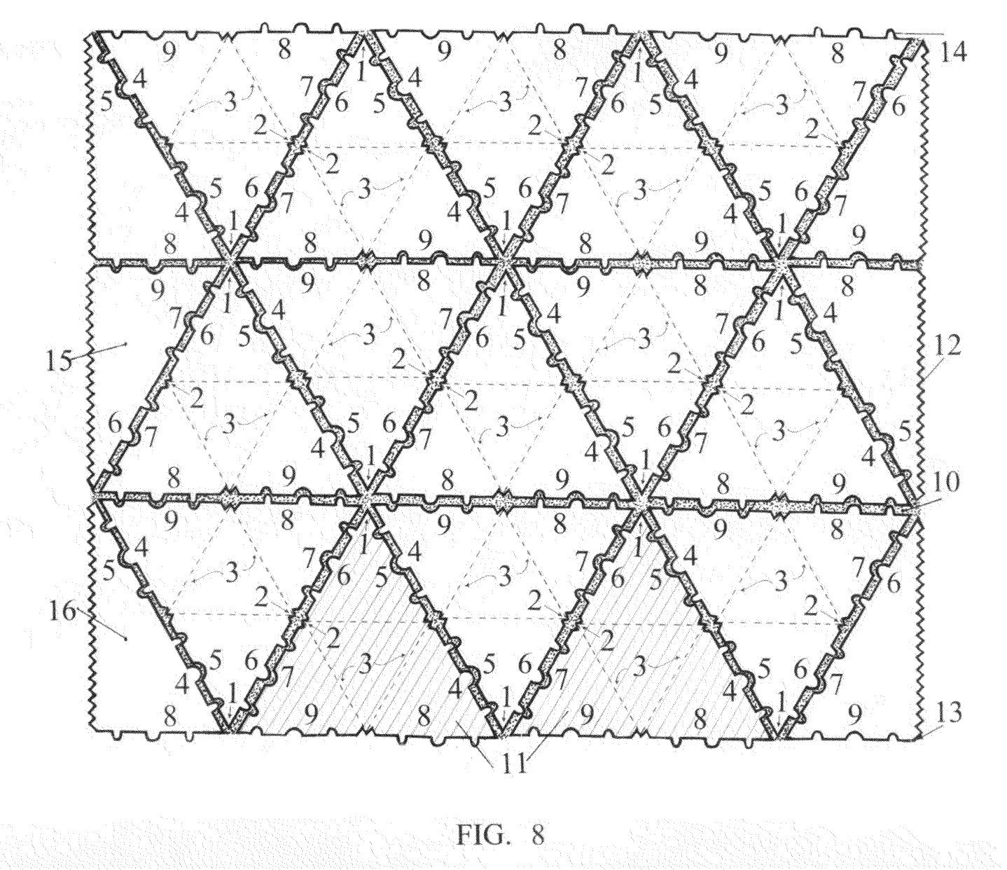

Item #4—side view of vacuum half canisters with serrations (FIG. 8) Items 15 & 16

Item #5—CDX exterior plywood sheathing

Item #6—15 lb waterproof building felt

Item #7—2nd film of trapped insulating air at rear of vacuum canister

Item #8—exterior siding

Item #9—rear spacer

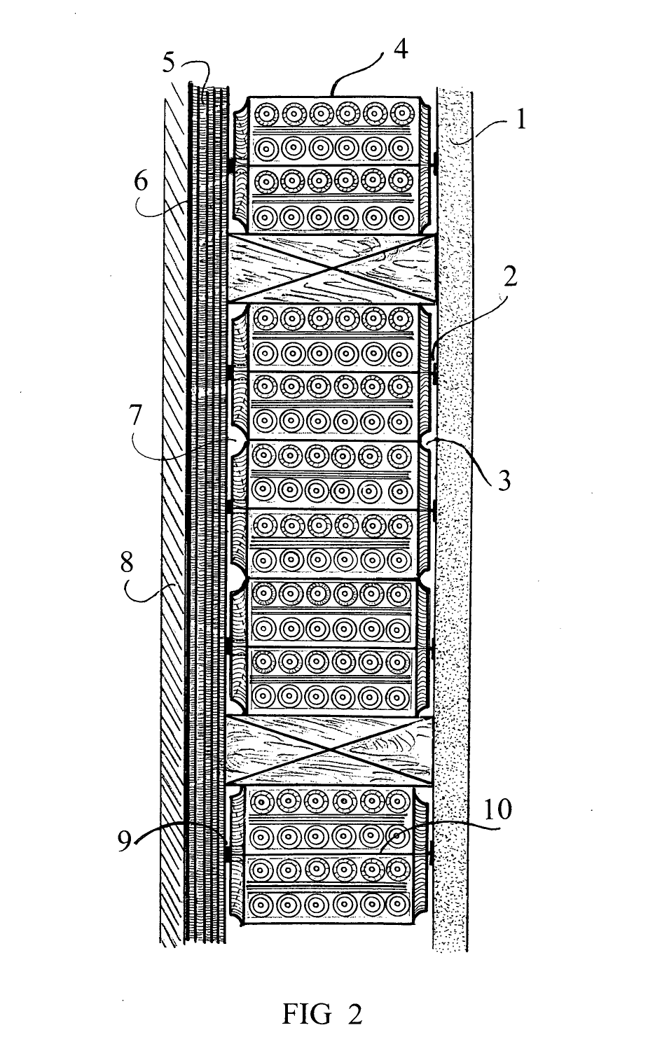

### FIG. 2

Item #1—gypsum wall board

Item #2—front spacer

Item #3—1st film of trapped insulating air at front of vacuum canister

Item #4—top aerial view of vacuum canister showing apex

Item #5—CDX exterior plywood sheathing

Item #6—15 lb waterproof building felt

Item #7—2nd film of trapped insulating air at rear of vacuum canister

Item #8—exterior siding

Item #9—rear spacer

Item #10—apex of vacuum canister

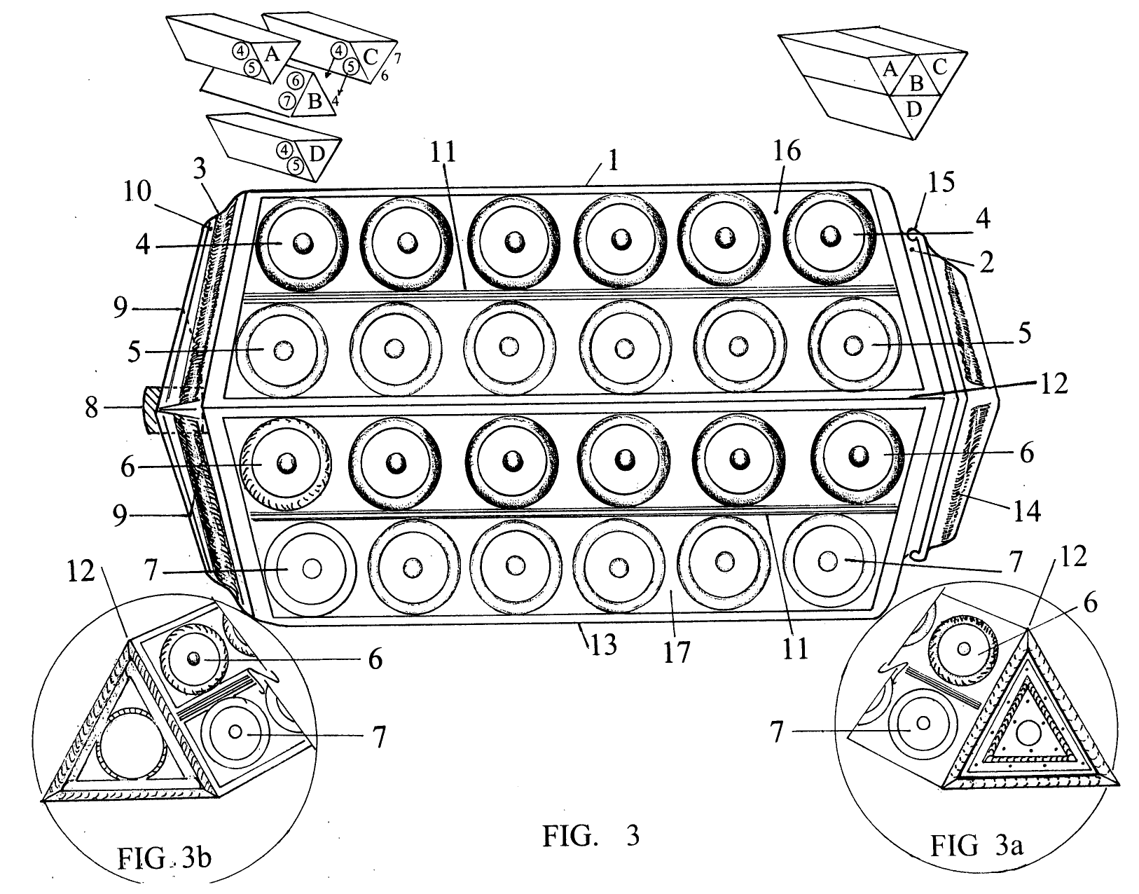

### FIG. 3

Item #1—right side of vacuum canister

Item #2—tapered top neck of vacuum canister

Item #3—tapered bottom neck of vacuum canister

Item #4—row of knob shaped raised circular ridges on right side of vacuum canister

Item #5—row of undercut circular depressions on right side of vacuum canister

Item #6—row of knob shaped raised circular ridges on left side of vacuum canister

Item #7—row of undercut circular depressions on left side of vacuum canister

Item #8—rear spacer

Item #9—circular concave structural depression

Item #10—bottom geometric shaped structural raised ridge

Item #11—vacuum canister's mid-line guide rail

Item #12—apex of vacuum canister

Item #13—left side of vacuum canister

Item #14—geometric raised ridge of top of lid-cap

Item #15—hermetically sealed lid-cap

Item #16—planar surface of right side of vacuum canister

Item #17—planar surface of left side of vacuum canister

### FIG. 3 a

Item #6—row of knob shaped raised circular ridges on left side of vacuum canister

Item #7—row of undercut circular depressions on left side of vacuum canister

Item #12—apex of vacuum canister

### FIG. 3 b

Item #6—row of knob shaped raised circular ridges on left side of vacuum canister

Item #7—row of undercut circular depressions on left side of vacuum canister

Item #12—apex of vacuum canister

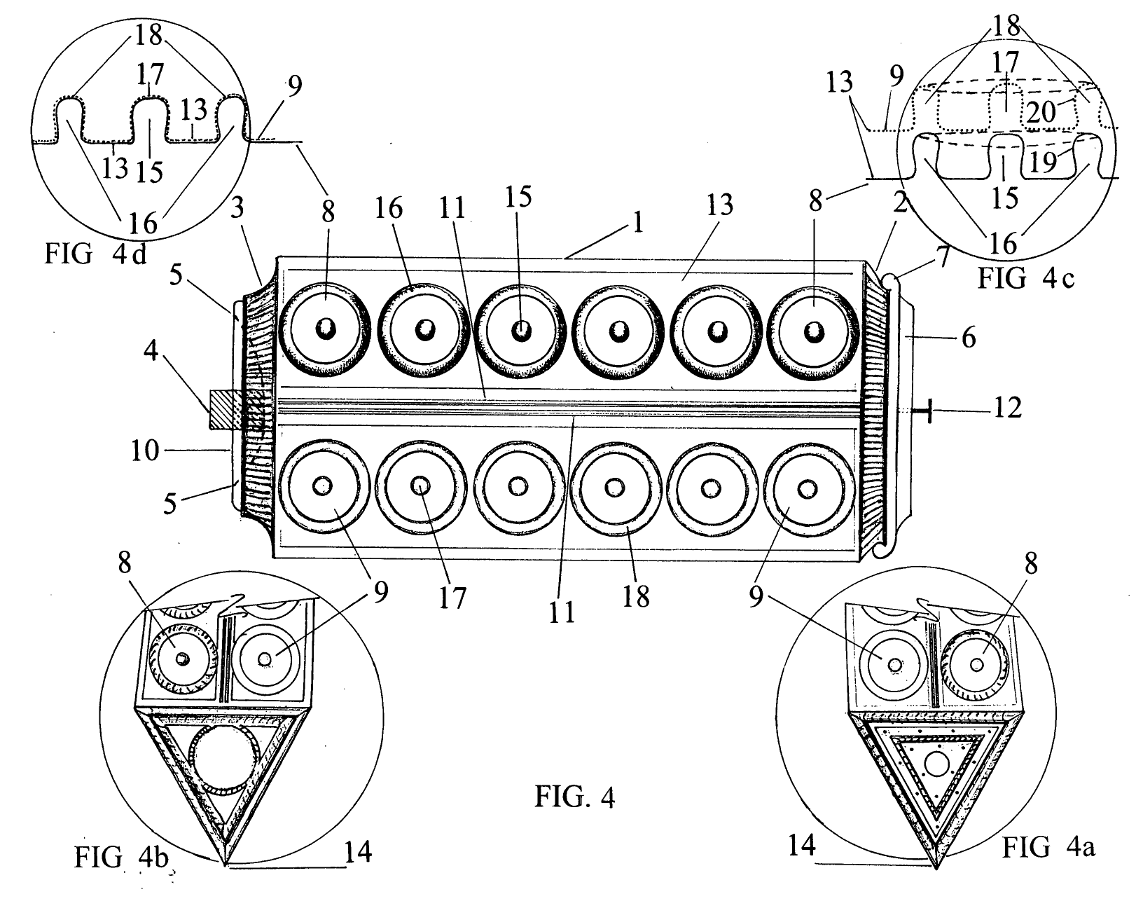

### FIG. 4

Item #1—bottom side of vacuum canister

Item #2—tapered top neck of vacuum canister

Item #3—tapered bottom neck of vacuum canister

Item #4—rear spacer

Item #5—circular concave structural depression

Item #6—top geometric shaped structural raised ridge

Item #7—pressed hermetically sealed top lid-cap

Item #8—row of knob shaped raised circular ridges on bottom side of vacuum canister

Item #9—row of undercut circular depressions on bottom side of vacuum canister

Item #10—bottom geometric shaped structural raised ridge

Item #11—vacuum canister's mid-line guide rail

Item #12—front spacer

Item #13—planar surface of bottom side vacuum canister

Item #14—apex of vacuum canister

### FIG. 4 a

Item #8—row of knob shaped raised circular ridges-bottom front of vacuum canister

Item #9—row of undercut circular depressions on bottom front face of vacuum canister

### FIG. 4 b

Item #8—row of knob shaped raised circular ridges-bottom rear face of vacuum canister 12

Item #9—row of circular depressions on bottom side rear face of vacuum canister

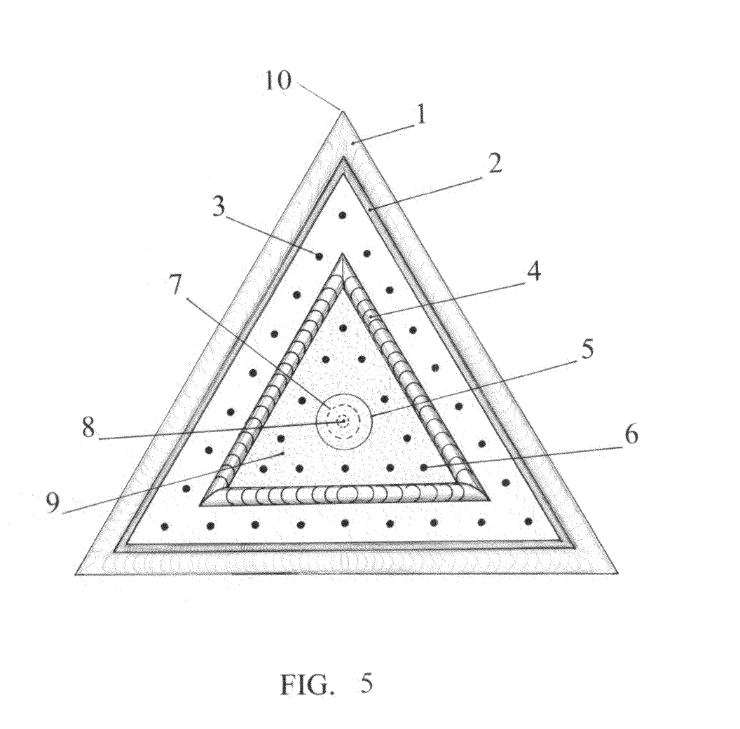

### FIG. 5

Item #1—tapered top neck of vacuum canister

Item #2—top lid-cap

Item #3—top outer perimeter sealing rivets

Item #4—top geometric shaped structural raised ridge

Item #5—larger sealed circular depression disk

Item #6—top inner boundary sealing rivets

Item #7—smaller sealed circular depression disk beneath Item #5

Item #8—circular aperture annular ring immediately beneath Item #7

Item #9—fast curing liquid organic polyurethane type sealant

Item #10—apex of vacuum canister

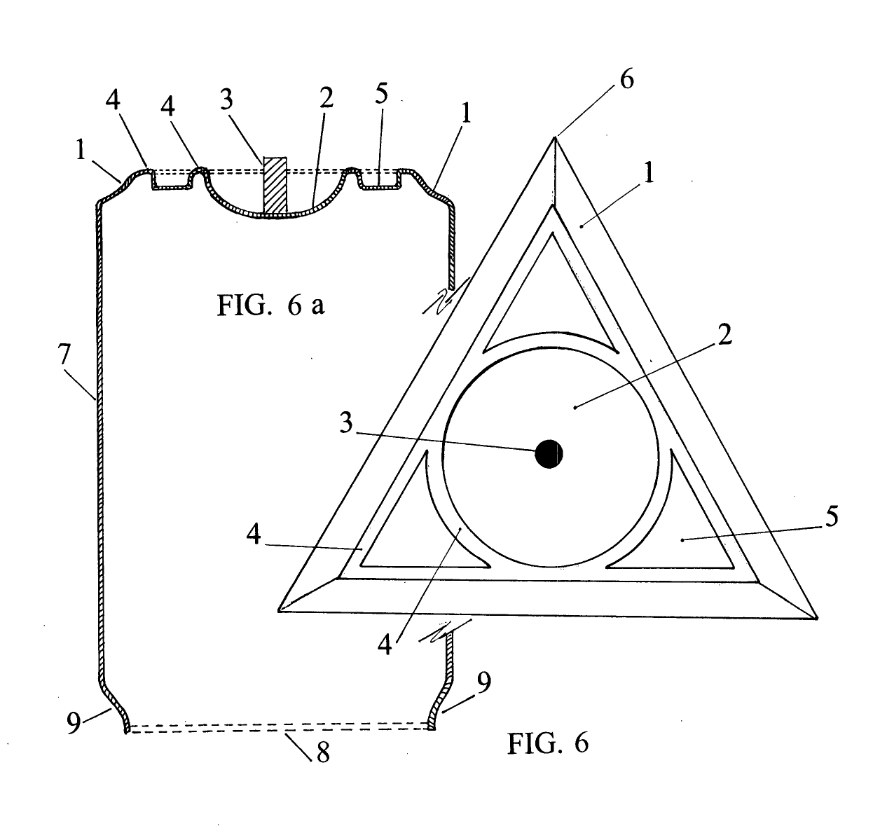

### FIG. 6

Item #1—tapered bottom neck of vacuum canister

Item #2—circular concave structural depression

Item #3—rear spacer

Item #4—bottom geometric shaped structural raised ridge

Item #5—bottom planar surface of vacuum canister

Item #6—apex of vacuum canister

Item #7—entire length of vacuum canister

Item #8—top perimeter boundary of vacuum canister eventually sealed by lid-cap

Item #9—tapered top neck of vacuum canister

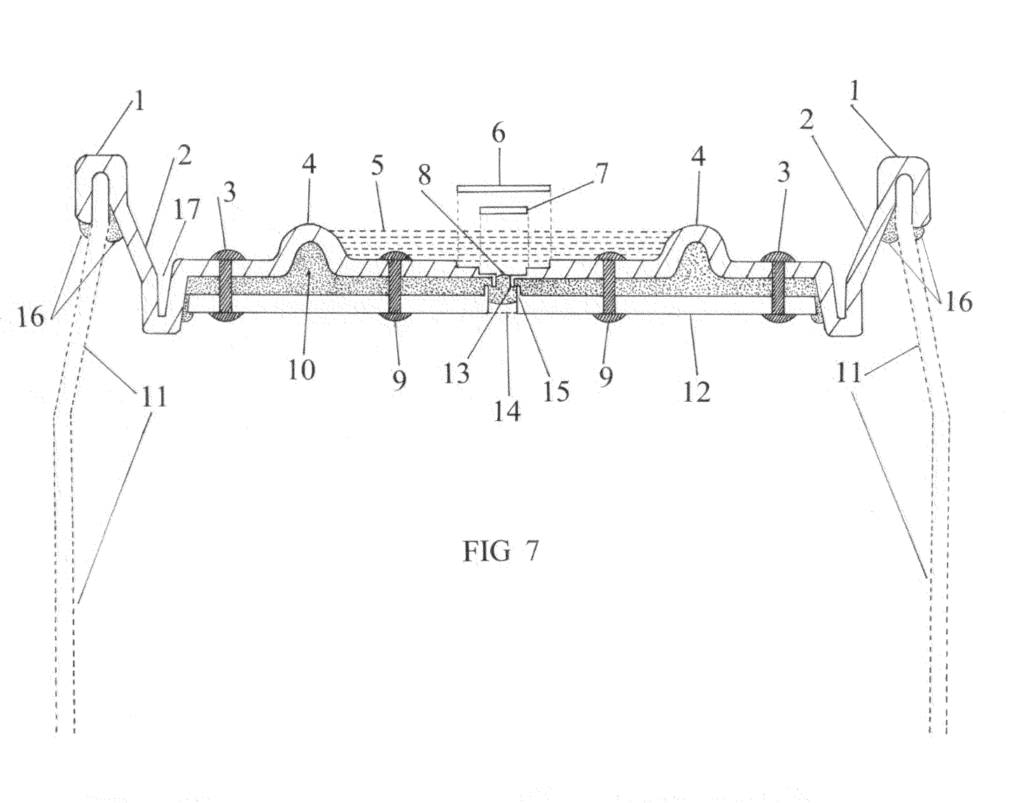

### FIG. 7

Item #1—top lid-cap

Item #2—structural taper in top lid-cap layer

Item #3—top outer perimeter sealing rivets

Item #4—top geometric shaped structural raised ridge

Item #5—fast curing liquid organic polyurethane type sealant

Item #6—larger circular seal depression disk

Item #7—smaller circular seal depression disk

Item #8—upper layer circular aperture

Item #9—top inner boundary sealing rivets

Item #10—pre-formed compressible rubber packing seal

Item #11—entire length of vacuum canister shown with top tapered neck

Item #12—bottom riveted layer of lid cap assembly

Item #13—top upper layer concentric inner annular rim circular aperture projection

Item #14—bottom layer circular aperture immediately beneath Item #8

Item #15—bottom lower layer concentric outer annular rim circular aperture projection

Item #16—lid-cap silicone hermetic sealants

### FIG. 8

Item #1—apex of vacuum canister

Item #2—vacuum canister's mid-line guide rail

Item #3—open wire mesh grid which fits into Item #2's three midline slots (optional)

Item #4—row of knob shaped raised circular ridges on right side of vacuum canister

Item #5—row of undercut circular depressions on right side of vacuum canister

Item #6—row of knob shaped raised circular ridges on left side of vacuum canister

Item #7—row of undercut circular depressions on left side of vacuum canister

Item #8—row of knob shaped raised circular ridges on bottom side of vacuum canister

Item #9—row of undercut circular depressions on bottom side of vacuum canister

Item #10—organic structurally engineered adhesive bonding glue (Loctite)

Item #11—two specially configured canisters with Items #8 & #9 positions reversed

Item #12—serrated saw-tooth structural ribbing in contact with 2″×4″ wood studs

Item #13—bottom row of vacuum canister module which inserts into top row Item #14

Item #14—top row of vacuum canister module which inserts into bottom row Item #13

Item #15—special structurally designed sides of half canisters (typical of three)

Item #16—special structurally designed sides of half canisters (typical of three)

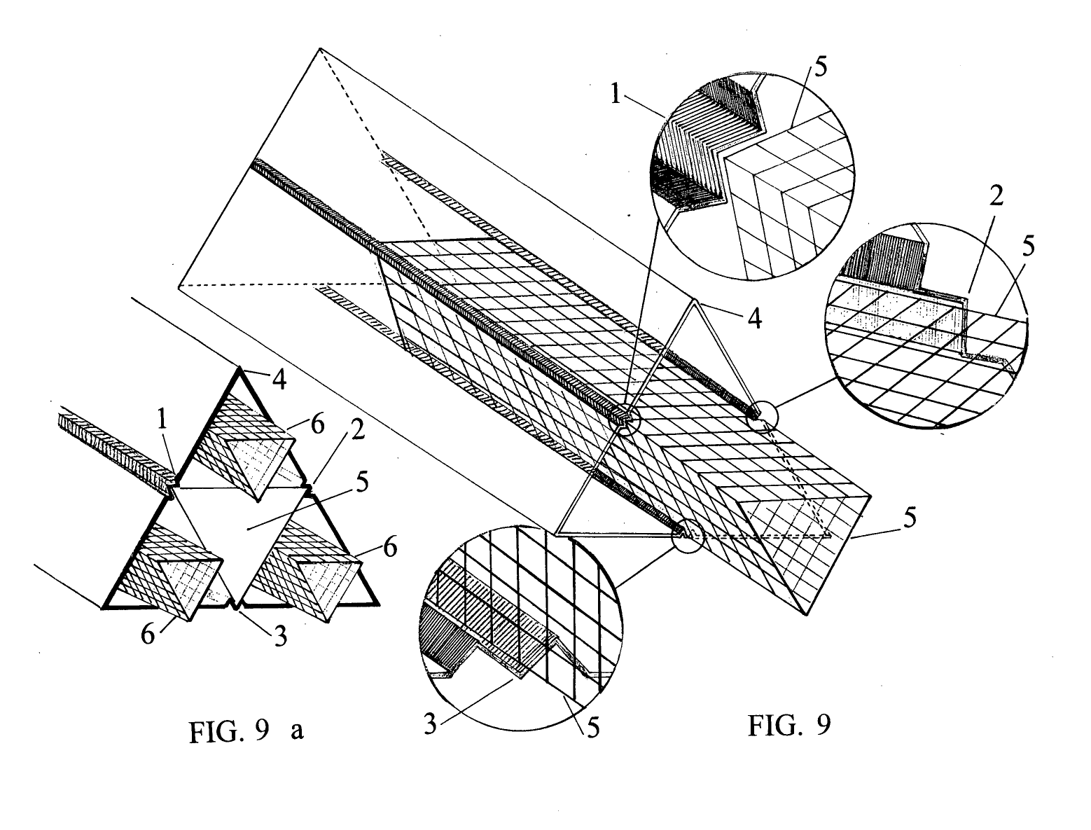

### FIG. 9

Item #1—vacuum canister's mid-line guide rail for left side

Item #2—vacuum canister's mid-line guide rail for right side

Item #3—vacuum canister's mid-line guide rail for bottom

Item #4—apex of vacuum canister

Item #5—open wire mesh grid which fits into three midline slots (optional if needed)

Item #6—additional open wire mesh grids (optional if structurally needed)

### DETAILED DESCRIPTION

### Preferred Embodiment

### Element “a” of Claim 1

### Open Vessel

The article of manufacture for this invention; solely with regard to its static physical structure and assembly begins by the formation of Element “a” under Claim #1 with the deep drawing of a sheet of malleable material via a forming process in which a seamless sheet of material blank is radially drawn into a forming die, by the mechanical action of a punch within a double-action mechanical press. It is thus a shape transformation process with complete material retention. Any wrinkles within this seamless material can be prevented, by using a blank holder; the function of which is to facilitate controlled material flow into the die radius. Thus, this fabrication process essentially begins through a mechanical cold forming process that starts with punching a flat blank from a very stiff cold-rolled sheet. This sheet is typically alloy 3104-H19, which is aluminum with about 1% manganese and 1% magnesium to give it strength and formability. The flat blank is first formed into a cup-like shape, which is then pushed through a different forming process called “ironing” which forms the open vessel. The bottom of the vessel is also shaped at this time whereby this malleable material deforms into the shape of an open vessel. This operation results in an open ended seamless vessel as configured in FIG. 6a. At the terminal underside end of said open vessel, a bottom forming die located at the lower end of the mechanical press contains a raised relief pattern which results in the planar surface of Item #5 of FIG. 6a being shaped, in conjunction with its opposing die of said penetrating deep draw punch. The latter also contains a raised relief pattern, which results in the creation of Item #4—FIG. 6a; . . . which is the structural geometric raised ridge as being formed simultaneously. This same bottom forming die, also located at the lower end of the mechanical press contains a raised relief shape which will configure the bottom tapered neck shown as Item #1—FIG. 6a; while simultaneously, an accessory forming die configures the concave structural circular depression shown as Item #2—FIG. 6a. Concurrent with this shaping process, the upper end of the punch contains another accessory forming die which creates the top tapered neck of said open vessel as shown by Item #9—FIG. 6a.

Subsequently, said partially completed open vessel is withdrawn from the mechanical press; whereupon a separate forming die, with alternating rows of relief patterning, containing knob shaped raised concentric circular ridges, alternating with concentric rows of undercut circular depressions is inserted internally within the open vessel. Corresponding separate companion forming dies are then positioned opposite and external to this internal die, on each of the open vessel's sides; whereby the resulting complementary and corresponding opposing patterns are thus stamped as alternating symmetrical circular knob shaped raised ridges depicted by Items #4 and #6 of FIG. 3 as well as Item #8 of FIG. 4. Likewise, and simultaneous with this operation, the symmetrically positioned concentric undercut circular depressions shown by Items #5 and #7 of FIG. 3 and Item #9 of FIG. 4 are impressed. A key feature or operation yet to be performed after the circular knob shaped raised ridges and undercut circular depressions are shaped is the following process. A special tool is employed to burnish away the under-part or underside of each raised ridge and depression so as to leave an overhanging portion in relief. This slight bulge-like knob shape is depicted as Item #15—FIG. 4 c which acts as the knob shaped snap-in “stud”; while Item #16—FIG. 4 d shows the completed undercut union, which circular undercut depression acts as the “socket” receiving the snap-in knob shaped raised ridge stud. This snap in feature is explained in lucid detail below dealing with the assembly of Elements “a” and “b”. Also simultaneous with this foregoing process is the forming of the midline guardrail indentations on each of the open vessel's sides as shown by Item #1; Item #2 and Item #3 of FIG. 9. These foregoing processes all constitute the entire fabrication process of the open vessel comprising only Element “a” within claim 1.

### ELEMENT “b” of Claim 1

### Top Layer

The process involved in the fabrication of Element “b”—claim 1 involves sheet blanks of similar malleable material, typically alloy 5182-H48, which are usually stamped from a coil of aluminum. These two separate parts consist of a “top layer” and a “bottom layer”, separated by a gasket type seal of compressible rubber material;—See FIG. 7. Item #10. At first, the top layer is subjected to a punching press, which blanks out only the holes associated with the top layer shown by FIG. 5—as follows: the 24 outer perimeter holes—for insertion of the outer rivets, as shown by Item #3—FIG. 5 and FIG. 7; as well as the 12 inner boundary holes shown by Item #6—FIG. 5 and Item #9—FIG. 7; for insertion of the inner boundary rivets; and finally, the sole aperture of Item #8—FIG. 7. All of these foregoing holes are punched out simultaneously. The next fabrication process for the top layer involves several forming dies and a specialized punch within a double-action mechanical press. First the larger circular seal depression lying immediately above the aperture of Item #8—FIG. 7 is formed, as a one layer thick circular depression within said top layer; which eventually will receive the identically sized circular disk shown by Item #6—FIG. 7. Next, the smaller circular seal depression is formed also as a one layer thick depression concentrically positioned within the larger depression, just one layer's thickness below the latter; which will eventually receive the identically sized circular disk shown by Item #7—FIG. 7. Further, under a separate operation these foregoing sealing disks shown as Item #6 and Item #7—FIG. 7 are punched out of separate material for later use, to be discussed below. Both of these sealing disks must be equal in size to their respective recessed depressions previously formed.

Item #1—FIG. 7 is the quintessential lid-cap configuration, which is bent at the critical angle shown, via a bending die. Forming dies will subsequently shape the structural formation of this lid-cap design by way of a sloped incline shown as Item #2—FIG. 7; while another separate bending die forms the structural crevice shown as Item #17—FIG. 7. Simultaneously, a relief die with a raised ridge pattern positioned at the lower end of the mechanical press imparts the stamped out shape shown as the raised structural ridge of Item #4—FIG. 7. Finally, the last item of fabrication within the top layer of Element “b”—claim 1 is the downward concentric inner circular aperture annular rim projection which is shown as Item #13—FIG. 7.

### Bottom Layer

Fabrication of the bottom layer of Element “b”—claim 1 shown as Item #12—FIG. 7; which ultimately resides immediately beneath the aforementioned top layer, (only separated by the compressible rubber gasket seal) begins similarly with a punching press operation, which blanks out the holes associated with said bottom layer as follows: the 24 outer perimeter holes (for the insertion of the outer rivets) are identically patterned and positioned to line-up and correspond with the holes of the aforementioned top layer; and are stamped out as shown by the outer rivets as Item #3—FIG. 7. Next, the 12 inner boundary holes are simultaneously blanked out for the insertion of the inner boundary rivets depicted as Item #9—FIG. 7, while the same simultaneous blanking operation is completed as the sole aperture of Item #14—FIG. 7. The last fabrication step for the bottom layer is accomplished by a punching die extruding a slight amount of material from the bottom layer in the immediate vicinity of the aperture, by pushing or thrusting out a circular concentric upward pointing annular protruding rim, which is larger in circumference than the top layer's downward pointing annular protruding rim. Said former larger rim is shown as Item #15—FIG. 7. Both top and bottom annular rims help create the hermetic seal to shut out any unwanted outside atmospheric air form entering the closed sealed vessel.

### Compressible Seal Gasket

Sandwiched in between both the top and the bottom layers is a pre-formed compressible rubber gasket seal shown as Item #10—FIG. 7; which is made of elastic material, essentially running the entire length of the void space created within the two opposing top and bottom layers of Element “b”—claim 1. It is noteworthy to emphasize that the bottom layer of Element “b” is somewhat shorter in length than the complete underside of its corresponding top layer, so that when both top and bottom layers are tightly riveted together in close proximity to one another; said compressible material at the outer perimeter limits of the lid-cap assembly will bulge out into the space below as shown in FIG. 7; and thus form a hermetic sealing bead, which totally prevents air from entering the vacuumed out hollow canister subsequently to be assembled. In a similar fashion, this same pre-formed protuberance of the compressible material also fills the void within the raised structural ridge shown as Item #4—FIG. 7. Finally, this same similar occurrence also takes place as a consequence of the aforementioned riveting operation of all 24 outer perimeter rivets, as well as the 12 inner boundary rivets; whereby the upward projecting concentric circular annular rim shown as Item #15—FIG. 7 helps squeeze the compressible material by exerting sufficient annular pressure, which automatically creates a bulge to both hermetically seal and prevent air leaks from eventually entering the soon to be closed vessel. A similar concomitant compressive action takes place simultaneously with respect to the top layer's downward projecting concentric circular annular rim shown as Item #13—FIG. 7; which also helps squeeze said compressible material upward into the smaller disk-like concentric circular depression of Item #7—FIG. 7.

### Assembly of Elements “a” and “b” of Claim 1

The completed lid-cap assembly of Element “b” is subsequently placed over the top tapered neck area of Element “a” shown as Item #9—FIG. 6; then crimped in two operations. A seaming head engages the lip-cap from above while a seaming roller to the side curls the edge of the lid around the edge of the open vessel body of Element “a” the head and roller spin the open vessel around its entire perimeter to seal the unit all the way around. Then a pressure roller with a different profile drives the two edges together under tremendous pressure to make an air-tight hermetic seal.

### Assembly of One Typical Modular Unit Under Claim 3

The completed assembly of a multitude of units of Elements “a” and “b” comprise a unitary modular whole when fifteen similar shaped closed vessels are arranged in a pattern shown in FIG. 8. The top row units shown by Item #14—FIG. 8 depicts a pattern whereby three hermetically sealed closed vessels are inverted with their apex pointed downward as indicated by Item #1—FIG. 8. As such, the void created by this pattern allows the insertion in between the latter three vassels of two additional hermetically sealed closed vessels, such that their respective apexes are instead positioned upright. The completion of this first upper row is accomplished with the insertions of two dissimilar half-sized hermetically sealed closed vessels fabricated with a specialized saw-tooth like end configuration. The half-sized unit on the left is identical to Item #16—FIG. 8; while the half-sized unit on the right is identical to Item #15—FIG. 8 only inverted in position. This arrangement completes the top row. The middle row is formed in opposite fashion where only two hermetically sealed closed vessels are positioned at the top with their apexes pointing downward; while the respective voids formed by their arrangement permits three identical units, inverted in orientation such that their respective apexes all point upward. Item #15—FIG. 8 completes the left side closure; while Item #16—FIG. 8 thus inverted completes the right side of said middle row. The last row, indicated as Item #13—FIG. 8 is identical with the arrangement of the first row. This entire array portrays a pattern of arrangement such that there are only two different kinds of half-sized pieces with specialized serrated saw-tooth pattern; however the total number needed to complete this entire lateral arrangement is thus six.

The only other distinguishing characteristic within this array is that in order to effectuate a complete interlocking of all hermetically sealed closed vessels, it is necessary to manufacture two different closed vessels shown by the cross-hatched area indicated as Item #11—FIG. 8. The difference is such that the uncut circular depressions of Item #9—FIG. 8, as well as the knob shaped raised circular ridges of Item #8—FIG. 8 are reversed in position relative to the other units. The final stage of completion involves all interlocking surface areas to be completely brushed with a strong structural or engineering type adhesive such as thermosetting, thermoplastic or elastomeric epoxy glues, examples of which are “ARALDITE”, marketed by Ciba Corp. or “EPON” or LOCTITE, marketed by Henkel; whereby each unit is then snapped tightly into its respective neighboring counterpart; much like the male and female snap-like counterparts on a garment. It can thus be visualized that every knob shaped raised circular ridge “male” component fits intimately by snapping tightly into every “female” undercut circular depression. It is the undercut which securely bonds the two elements tightly together. In this manner these two opposing “male” and “female” forms are intimately and tightly mated together. It is noteworthy to point out that the undercut depressions may have to be pre-heated; ergo expansion, in order to insure easy interlocking elements. Hence, as shown in FIG. 8, knob shaped raised Item #4 fits neatly into the undercut depression of Item #5. Similarly, knob shaped raised Item #6 fits into the undercut depression of Item #7; while knob shaped raised Item #8 fits into the undercut depression of Item #9. In an identical fashion, the top row of Item #14 fits tightly into the bottom row of Item #13. These glued modules arranged as such fit into the building construction as shown by Item #4-FIG. 2, which depicts the completed vacuum canister with its front spacer, shown as Item #2—FIG. 2 in back of the gypsum wall board shown by Item #1—FIG. 2. Whereas the rear spacer of the vacuum canister is shown as Item #9—FIG. 2; completely in front of the CDX exterior plywood sheathing shown as Item #5—FIG. 2. It is also noteworthy to point out that said front spacer automatically creates a trapped insulating air space shown by Item #3—FIG. 2; while the rear spacer creates a similar trapped air space shown as Item #7—FIG. 2. The apex of each vacuum canister helps orient the three vacuum canisters as fitting completely within the 2″×4″ wood stud to wood stud 16″ on center construction standard, shown by Item #10—FIG. 2. FIG. 1 is also a cross section through the same building materials, except that its graphic orientation depicts the six end closure side vacuum canisters shown as Items #15 and Items #16—FIG. 8.

### Completed Vacuum Canisters Under Claims 4 & 5

The complete assembly of one modular unit comprising fifteen full-sized closed vessels as shown in FIG. 8 along with six serrated half-sized side closure units, also shown in FIG. 8 as Items 15 & 16; allows the final functional operation to take place. Twenty-one individual needle-like apparatus attached to one vacuum pump assembly via manifold are then inserted into the twenty-one apertures shown by Items #8—FIG. 7 and Item #14—FIG. 7; obviously, inserted completely through the compressible rubber material of Item #10—FIG. 7. The complete air contents of all twenty-one closed vessels are summarily evacuated. The precise volume of air removed must be calculated to equal the known volume of air therein prior to removal. Subsequently, the twenty-one needle-like apparatus is removed, with the immediate glued in place insertion of the two circular concentric annular disks shown by Item 6 & Item 7—FIG. 7 is then accomplished. Next, the entire volumetric area of the structural raised ridge shown by Item #4—FIG. 7, as well as Item #9—FIG. 5 is completely immersed in a polyurethane sealant or other similar organic sealing lacquer, which provides an impermeable outer surface layer over the entire area. Examples of suitable sealants include sealing lacquers comprised of solvents with high polymers by Leybold, and the following sealants: Glyptal Lacquer or Anaerobic Permafil by G.E. and Loctite such as depicted by Item #5—FIG. 7; after which the front spacer shown by Item #2—FIG. 2 is put in place immediately and well before curing takes place. Finally, the rear spacer, shown by Item #3—FIG. 6 is also glued into position. Thus, the entire vacuum canister is ready for installation within the 2″×4″ wood stud space. (See FIG. 2.)

### Optional Open Wire Mesh

Only by empirical evidence can it be ascertained that when the air contents are summarily removed from the vacuum canisters, whereupon it is subsequently observed that the sides of the evacuated vessels collapse from excessive atmospheric pressure, then one proper remedy; aside from selecting a stronger gauge material, is the following. Item #5—FIG. 9 depicts a open wire mesh grid which must be guided into position prior to the top tapered neck of Item #9—FIG. 6 being formed. This open wire mesh grid is slotted into its respective positions shown within FIG. 9 as Item #1; Item #2 and Item #3.

Should the un-reinforced sides of the evacuated vacuum vessel still undergo deformation; then a further option must be employed. FIG. 9 a depicts the same open wire mesh grid arrangement as FIG. 9 except there the new optional arrangement would be to insert three additional smaller open wire mesh grids as shown. Upon completion it will be empirically observed that no deformation or collapse can occur whatsoever.

1. I claim, a building insulating device made from light, reflective malleable material which creates a hermetically sealed hollow vessel with a state of vacuum therein having high thermal insulating value for thermal resistance with a concomitant lowered thermal conductivity,” both of which significantly retard a building's heat transfer flux comprising essentially two elements as:
(a) . . . a seamless die-formed open ended geometrically shaped hollow vessel having symmetrically positioned rows of knob shaped raised ridges alternating with rows of identically shaped undercut depressions from its common planar surfaces, and . . .
(b) . . . a die formed lid-cap assembly fabricated from two separate layers of similar material as element (a), which layers, when bonded together, thus sandwich and squeeze a pre-formed compressible material; whereby both elements (a) and (b) are subsequently mechanically bonded as one closed vessel by pressing each element tightly together, thus rendering said vessel's enclosed interior as being hermetically sealed.

2. The subject matter of claim 1, in its initial functional phase provides the means by which the lid-cap assembly of element (b); being comprised of a structural raised ridge, acts in unison with its underlying bonded bottom layer to squeeze the pre-formed compressible material significantly, and in consort with each opposing layer's structurally projecting concentric annular rims; which lie in close proximity to both aperture openings, help create a hermetic air tight seal within said enclosed hollow vessel.

3. The subject matter of claim 1, in its next functional phase provides the means by which the entire surface areas of the entirety of elements (a) are completely covered with a bonding adhesive, thereby enabling the tightly glued adhesive union of all knob shaped raised ridges of element (a) to intimately snap and fit into all of the identically sized undercut depressions of an adjoining element (a); whereby each of element (a)'s total surface area is in intimate tight contact with all of its abutting element (a) neighbors, thus forming one unified modular assembly into a cohesively bonded whole unit comprising a multitude of hermetically sealed air tight hollow vessels.

4. The subject matter of claim 1, in its penultimate functional phase provides the means within the completed sealed lid-cap assembly of element (b) for the introduction of a needle-like apparatus piercing through the compressible material via both patent apertures, thus allowing the subsequent withdrawal by vacuum pump of all interior air contents from the enclosed vessel, thereby creating negative atmospheric pressure within as a true vacuum state, which then creates an inability for allowing the transfer of heat loss or heat gain in either direction therein.

5. The subject matter of claim 1, in its final functional phase provides the means for the complete withdrawal of the needle-like apparatus from both apertures with the immediate subsequent covering and gluing of two concentric annular sealing disks within their respective shallow depressions, coupled with the complete pouring of a quick-curing liquid organic compound within the area bounded by the raised ridge of the lid-cap assembly of element (b); thereby permanently and hermetically sealing off both apertures from any entry of air therein.
